(19) United States
(12) Patent Application Publication
(10) Pub. No.: US 2025/0249666 A1
(43) Pub. Date: Aug. 7, 2025

(54) LAMINATE

(71) Applicant: DAIKIN INDUSTRIES, LTD., Osaka (JP)

(72) Inventors: Kozue KOMAZAWA, Osaka (JP); Takeshi INABA, Osaka (JP)

(73) Assignee: DAIKIN INDUSTRIES, LTD., Osaka (JP)

(21) Appl. No.: 19/093,931

(22) Filed: Mar. 28, 2025

Related U.S. Application Data
(63) Continuation of application No. PCT/JP2023/026788, filed on Jul. 21, 2023.

(30) Foreign Application Priority Data
Sep. 30, 2022 (JP) 2022-157963

(51) Int. Cl. B32B 25/02; B32B 25/08

(52) U.S. Cl. CPC B32B 25/02; B32B 25/08; B32B 2264/10; B32B 2307/202; B32B 2307/7376

(57) ABSTRACT

Provided is a laminate comprising a rubber layer (A), and a fluororesin layer (B) laminated on the rubber layer (A), wherein the rubber layer (A) is a layer having conductivity and is formed from a rubber composition comprising a rubber and a carbon black, a content of the carbon black in the rubber composition is 1.0 to 100 parts by mass based on 100 parts by mass of the rubber, and a nitrogen adsorption specific surface area of the carbon black is 140 m²/g or less, and the fluororesin layer (B) is formed of a melt-fabricable fluororesin.

### CROSS-REFERENCE TO RELATED APPLICATIONS

This application is a Rule 53 (b) Continuation of International Application No. PCT/JP2023/026788 filed Jul. 21, 2023, which claims priority based on Japanese Patent Application No. 2022-157963 filed Sep. 30, 2022, the respective disclosures of which are incorporated herein by reference in their entirety.

### TECHNICAL FIELD

The present disclosure relates to a laminate.

### BACKGROUND ART

Patent Document 1 discloses a laminate comprising a fluoroelastomer layer (A); and a fluoropolymer layer (B) on the fluoroelastomer layer (A),
the fluoroelastomer layer (A) being a layer formed of a fluoroelastomer composition for crosslinking, the fluoroelastomer composition for crosslinking containing an uncrosslinked fluoroelastomer, silica particles, and a basic polyfunctional compound, an average value of products of “(particle size)×(roundness)” of silica particles being 17.5 nm or more and 500 μm or less, and silica particles being contained in the fluoroelastomer composition for crosslinking in an amount of 1 part by mass or more and 70 parts by mass or less per 100 parts by mass of the uncrosslinked fluoroelastomer, and
the fluoropolymer layer (B) being a layer formed of a fluoropolymer composition, the fluoropolymer composition containing a fluoropolymer, the fluoropolymer being a chlorotrifluoroethylene copolymer or a tetrafluoroethylene copolymer, and the tetrafluoroethylene copolymer containing tetrafluoroethylene unit, and a unit derived from at least one monomer selected from the group consisting of perfluoro(alkylvinyl ether), vinylidene fluoride, and a monomer represented by the general formula CX⁸X⁹═CX¹⁰Y (wherein X⁸, X⁹, and X¹⁰ are each independently F or H, Y is —Cl or —Rf⁵—Br, and Rf⁵ is a single bond or C₁ to C₅ perfluoroalkylene).

### RELATED ART

### Patent Documents

Patent Document 1: International Publication No. WO2020/170025

### SUMMARY

According to the present disclosure, there is provided a laminate comprising a rubber layer (A), and a fluororesin layer (B) laminated on the rubber layer (A), wherein the rubber layer (A) is a layer having conductivity and is formed from a rubber composition comprising a rubber and a carbon black, a content of the carbon black in the rubber composition is 1.0 to 100 parts by mass based on 100 parts by mass of the rubber, and a nitrogen adsorption specific surface area of the carbon black is 140 m²/g or less, and the fluororesin layer (B) is formed of a melt-fabricable fluororesin.

### Effects

According to the present disclosure, there can be provided a laminate comprising a rubber layer and a fluororesin layer, wherein the rubber layer has conductivity, and the rubber layer and the fluororesin layer are adhered firmly to each other.

### DESCRIPTION OF EMBODIMENTS

Hereinafter, specific embodiments of the present disclosure will be described in detail, but the present disclosure is not limited to the following embodiments.

The laminate of the present disclosure comprises a rubber layer (A) and a fluororesin layer (B). Patent Document 1 discloses a laminate comprising a fluoroelastomer layer (A) and a fluoropolymer layer (B). However, a technique capable of imparting conductivity to the rubber layer of a laminate and adhering the rubber layer having conductivity and the fluororesin layer firmly to each other is desired.

The means for solving the above problem has been intensively studied, and as a result, it has been found that by selecting carbon black having a nitrogen adsorption specific surface area in a significantly limited range among a plurality of carbon black and by formulating a suitable amount of the carbon black in rubber, conductivity can be imparted to the rubber layer, and a laminate in which the rubber layer having conductivity and a fluororesin layer are adhered firmly to each other can be obtained.

Each component for constituting such an unconventional laminate will be described in detail below.

### (A) Rubber Layer

The rubber layer included in the laminate of the present disclosure has conductivity. The presence or absence of the conductivity of the rubber layer can be confirmed by, for example, measuring the surface resistance value of the rubber layer. The surface resistance value of the rubber layer is preferably 10 MΩ or less, more preferably 5 MΩ or less, and still more preferably 1 MΩ or less, from the viewpoint of sufficiently preventing the laminate from being charged.

The surface resistance value of the rubber layer can be measured, for example, using an insulation resistance tester.

The rubber layer is a layer formed from a rubber composition. The rubber layer is usually obtained by forming a rubber composition to obtain an uncrosslinked rubber layer, and then subjecting the uncrosslinked rubber layer to crosslinking treatment.

The rubber composition contains rubber and carbon black.

### (Carbon Black)

The rubber composition contains carbon black having a nitrogen adsorption specific surface area of 140 m²/g or less. By using the carbon black having a large nitrogen adsorption specific surface area, a laminate in which the rubber layer having conductivity and a fluororesin layer are adhered firmly to each other is obtained.

The nitrogen adsorption specific surface area of carbon black is 140 m²/g or less, preferably 120 m²/g or less, more preferably 100 m²/g or less, still more preferably 80 m²/g or less, particularly preferably 75 m²/g or less, most preferably 70 m²/g or less, and more preferably 25 m²/g or more.

The nitrogen adsorption specific surface area of carbon black can be determined in conformity with JIS K 6217-2.

The average primary particle size of carbon black is preferably 28 nm or more, more preferably 32 nm or more, still more preferably 35 nm or more, and preferably 200 nm or less, still more preferably 100 nm or less. By using carbon black having an average primary particle size within the above numerical value range, the laminate in which the rubber layer and the fluororesin layer are adhered firmly to each other is obtained.

The average primary particle size of carbon black is the arithmetic average particle size of the primary particles of carbon black. The average primary particle size of carbon black can be determined by observing the primary particles of carbon black with an electron microscope.

The content of the carbon black in the rubber composition is 1.0 to 100 parts by mass, preferably 3.0 parts by mass or more, more preferably 6.0 parts by mass or more, still more preferably more than 8.0 parts by mass, particularly preferably 9.0 parts by mass or more, and preferably 50 parts by mass or less, more preferably 30 parts by mass or less, still more preferably 20 parts by mass or less based on 100 parts by mass of the rubber. By setting the content of the carbon black having a large nitrogen adsorption specific surface area within the above range, the conductivity of the rubber layer and the adhesion between the rubber layer and the fluororesin layer can be improved, and the flexibility of the rubber layer and the physical properties of the rubber layer can be suitably adjusted.

As the carbon black contained in the rubber composition, carbon black having conductivity is used. By selecting carbon black having conductivity and selecting carbon black having a nitrogen adsorption specific surface area in a significantly limited range and by formulating a suitable amount of the carbon black in rubber, conductivity can be imparted to a rubber layer, and a laminate in which the rubber layer having conductivity and a fluororesin layer are adhered firmly to each other can be obtained. It is not easy to quantitatively evaluate the conductivity of the carbon black itself. However, in the laminate of the present disclosure, when carbon black is formulated in the rubber composition so as to achieve the content within the above range, carbon black having conductivity to such an extent that it can impart conductivity to the rubber layer is selected. In one embodiment, the type of carbon black and the content of carbon black are selected so that the surface resistance value of the rubber layer falls within the above range.

### (Rubber)

Examples of rubber contained in the rubber composition include diene-based rubber such as acrylonitrile-butadiene rubber (NBR) and hydride thereof (HNBR), styrene-butadiene rubber (SBR), chloroprene rubber (CR), butadiene rubber (BR), natural rubber (NR), and isoprene rubber (IR), ethylene-propylene-termonomer copolymerized rubber, silicone rubber, butyl rubber, epichlorohydrin rubber, acrylic rubber, chlorinated polyethylene (CPE), polyblend of acrylonitrile-butadiene rubber and vinyl chloride (PVC-NBR), ethylene propylene diene rubber (EPDM), chlorosulfonated polyethylene (CSM), and fluoroelastomer.

Among these, rubber is preferably fluoroelastomer. The fluoroelastomer is usually formed from an amorphous polymer having a fluorine atom that is coupled with a carbon atom constituting the main chain and has rubber elasticity. The fluoroelastomer may be formed from one polymer, or may be formed from two or more polymers. The fluoroelastomer usually has no obvious melting point.

The fluoroelastomer is preferably at least one selected from the group consisting of vinylidene fluoride (VdF)/hexafluoropropylene (HFP) copolymers, VdF/HFP/tetrafluoroethylene (TFE) copolymers, TFE/propylene copolymers, TFE/propylene/VdF copolymers, ethylene/HFP copolymers, ethylene/HFP/VdF copolymers, ethylene/HFP/TFE copolymers, VdF/TFE/perfluoro(alkyl vinyl ether) (PAVE) copolymers, VdF/chlorotrifluoroethylene (CTFE) copolymers, and VdF/CHX¹═CX²Rf¹ copolymers wherein one of X¹ and X² is H and the other is F, and Rf¹ is a linear or branched fluoroalkyl group having 1 to 12 carbon atoms. The fluoroelastomer is preferably a non-perfluoroelastomer, more preferably a copolymer containing a polymerized unit derived from vinylidene fluoride (VdF unit).

The VdF unit-containing copolymer is preferably a copolymer containing a VdF unit and a copolymerized unit derived from a fluorine-containing ethylenic monomer (excluding a VdF unit, hereinafter, also referred to as “fluorine-containing ethylenic monomer unit (a)”). The VdF unit-containing copolymer may consist only of a VdF unit and a fluorine-containing ethylenic monomer unit (a), or may further contain a copolymerized unit derived from a monomer copolymerizable with VdF and a fluorine-containing ethylenic monomer (excluding VdF, hereinafter also referred to as “fluorine-containing ethylenic monomer (a)”).

The VdF unit-containing copolymer contains, relative to 100 mol % of the total of the VdF unit and the fluorine-containing ethylenic monomer unit (a), preferably 30 to 90 mol % of the VdF unit and 70 to 10 mol % of the fluorine-containing ethylenic monomer unit (a), more preferably 30 to 85 mol % of the VdF unit and 70 to 15 mol % of the fluorine-containing ethylenic monomer unit (a), still more preferably 30 to 80 mol % of the VdF unit and 70 to 20 mol % of the fluorine-containing ethylenic monomer unit (a).

The amount of the copolymerized unit derived from a monomer copolymerizable with VdF and the fluorine-containing ethylenic monomer unit (a) (excluding a VdF unit) is preferably 0 to 10 mol % relative to the total amount of the VdF unit and the copolymerized unit derived from the fluorine-containing ethylenic monomer (a).

Examples of the fluorine-containing ethylenic monomer (a) include fluorine-containing monomers such as TFE, CTFE, trifluoroethylene, HFP, trifluoropropylene, tetrafluoropropylene, pentafluoropropylene, trifluorobutene, tetrafluoroisobutene, PAVE, vinyl fluoride, compounds represented by the general formula (1):

CHX¹═CX²Rf¹ (1)
wherein one of X¹ and X² is H and the other is F, and Rf¹ is a linear or branched fluoroalkyl group having 1 to 12 carbon atoms;
and fluorovinyl ethers represented by the general formula (2):

CFX═CXOCF₂OR¹ (2)
wherein X are the same as or different from each other, and each represents H, F, or CF₃; and R¹ represents a linear or branched fluoroalkyl group having 1 to 6 carbon atoms and optionally containing one or two atoms which consist of at least one atom selected from the group consisting of H, Cl, Br, and I, or a cyclic fluoroalkyl group having 5 or 6 carbon atoms and optionally containing one or two atoms which consist of at least one atom selected from the group consisting of H, Cl, Br, and I. In particular, at least one selected from the group consisting of CH₂═CFCF₃, fluorovinyl ethers represented by the formula (2), TFE, HFP, and PAVE is preferred, and at least one selected from the group consisting of TFE, HFP, and PAVE is more preferred.

The PAVE is preferably a compound represented by the general formula (3):

CF₂═CFO(CF₂CFY¹O)ₚ—(CF₂CF₂CF₂O)_{q}—Rf (3)
wherein Y¹ represents F or CF₃; Rf represents a perfluoroalkyl group having 1 to 5 carbon atoms; p represents an integer of 0 to 5; and q represents an integer of 0 to 5.

The PAVE is more preferably perfluoro(methyl vinyl ether) or perfluoro(propyl vinyl ether), still more preferably perfluoro(methyl vinyl ether). Each of these may be used alone or in any combination.

Examples of the monomer copolymerizable with VdF and the fluorine-containing ethylenic monomer (a) include ethylene, propylene, and alkyl vinyl ethers.

Specific preferred examples of such a VdF unit-containing copolymer include at least one copolymer selected from the group consisting of VdF/HFP copolymers, VdF/HFP/TFE copolymers, VdF/CTFE copolymers, VdF/CTFE/TFE copolymers, VdF/PAVE copolymers, VdF/TFE/PAVE copolymers, VdF/HFP/PAVE copolymers, VdF/HFP/TFE/PAVE copolymers, VdF/CH₂═CFCF₃ copolymers, and VdF/TFE/CH₂═CFCF₃ copolymers. Particularly preferred among these VdF unit-containing copolymers is at least one copolymer selected from the group consisting of VdF/HFP copolymers and VdF/HFP/TFE copolymers from the viewpoint of heat resistance. These VdF unit-containing copolymers preferably meet the above-described compositional proportions of the VdF unit and the fluorine-containing ethylenic monomer unit (a).

The VdF/HFP copolymer preferably has a molar ratio of VdF/HFP of (45 to 85)/(55 to 15), more preferably (50 to 80)/(50 to 20), still more preferably (60 to 80)/(40 to 20).

The VdF/HFP/TFE copolymer preferably has a molar ratio of VdF/HFP/TFE of 30 to 85/5 to 50/5 to 40, more preferably a molar ratio of VdF/HFP/TFE of 35 to 80/8 to 45/8 to 35, still more preferably a molar ratio of VdF/HFP/TFE of 40 to 80/10 to 40/10 to 30, and most preferably a molar ratio of VdF/HFP/TFE of 40 to 80/10 to 35/10 to 30.

The VdF/PAVE copolymer preferably has a molar ratio of VdF/PAVE of 65 to 90/10 to 35.

The VdF/TFE/PAVE copolymer preferably has a molar ratio of VdF/TFE/PAVE of 40 to 80/3 to 40/15 to 35.

The VdF/HFP/PAVE copolymer preferably has a molar ratio of VdF/HFP/PAVE of 65 to 90/3 to 25/3 to 25.

The VdF/HFP/TFE/PAVE copolymer preferably has a molar ratio of VdF/HFP/TFE/PAVE of 40 to 90/0 to 25/0 to 40/3 to 35, more preferably 40 to 80/3 to 25/3 to 40/3 to 25.

The fluoroelastomer is also preferably a copolymer containing a copolymerized unit derived from a monomer that imparts a crosslinking site. Examples of the monomer that imparts a crosslinking site include iodine-containing monomers such as perfluoro(6,6-dihydro-6-iodo-3-oxa-1-hexene) and perfluoro(5-iodo-3-oxa-1-pentene) described in Japanese Patent Publication No. 5-63482 and Japanese Patent Laid-Open No. 7-316234, bromine-containing monomers described in Japanese Translation of PCT International Application Publication No. 4-505341, cyano group-containing monomers, carboxyl group-containing monomers, and alkoxycarbonyl group-containing monomers described in Japanese Translation of PCT International Application Publication No. 4-505345 and Japanese Translation of PCT International Application Publication No. 5-500070.

The fluoroelastomer is also preferably one having an iodine atom or a bromine atom at an end of the main chain thereof. A fluoroelastomer having an iodine atom or a bromine atom at an end of the main chain thereof can be produced by emulsion polymerization of monomers with a radical initiator in an aqueous medium in the presence of a halogen compound and substantially in the absence of oxygen. A typical halogen compound used may be, for example, a compound represented by the general formula:

R²IₓBr_{y}
wherein x and y each represent an integer of 0 to 2 and satisfy 1≤x+y≤2; and R² is a saturated or unsaturated fluorohydrocarbon group having 1 to 16 carbon atoms, a saturated or unsaturated chlorofluoro hydrocarbon group having 1 to 16 carbon atoms, a hydrocarbon group having 1 to 3 carbon atoms, or a cyclic hydrocarbon group having 3 to 10 carbon atoms and optionally replaced by an iodine atom or a bromine atom, each of which may optionally contain an oxygen atom.

Examples of the halogen compound include 1,3-diiodoperfluoropropane, 1,3-diiodo-2-chloroperfluoropropane, 1,4-diiodoperfluorobutane, 1,5-diiodo-2,4-dichloroperfluoropentane, 1,6-diiodoperfluorohexane, 1,8-diiodoperfluorooctane, 1,12-diiodoperfluorododecane, 1,16-diiodoperfluorohexadecane, diiodomethane, 1,2-diiodoethane, 1,3-diiodo-n-propane, CF₂Br₂, BrCF₂CF₂Br, CF₃CFBrCF₂Br, CFClBr₂, BrCF₂CFClBr, CFBrClCFClBr, BrCF₂CF₂CF₂Br, BrCF₂CFBrOCF₃, 1-bromo-2-iodoperfluoroethane, 1-bromo-3-iodoperfluoropropane, 1-bromo-4-iodoperfluorobutane, 2-bromo-3-iodoperfluorobutane, 3-bromo-4-iodoperfluorobutene-1,2-bromo-4-iodoperfluorobutene-1, and a monoiodo- and monobromo-substituted benzene, diiodo- and monobromo-substituted benzene, and (2-iodoethyl)- and (2-bromoethyl)-substituted benzene. These compounds may be used alone or in any combination.

In particular, it is preferable to use 1,4-diiodoperfluorobutane or diiodomethane from the viewpoints of polymerization reactivity, crosslinking reactivity, and easy availability.

The fluoroelastomer preferably has a Mooney viscosity (ML₁₊₁₀ (100° C.)) of 5 to 200, more preferably 10 to 150, still more preferably 20 to 100, from the viewpoint of good processability in the production of the rubber composition.

The Mooney viscosity can be determined in conformity with ASTM D 1646.
Measurement apparatus: MV2000E, ALPHA TECHNOLOGIES
Rotor rotation speed: 2 rpm
Measurement temperature: 100° C.

In the rubber composition, the rubber component preferably consists only of the fluoroelastomer.

### (Basic Polyfunctional Compound)

The rubber composition preferably further contains a basic polyfunctional compound. The rubber composition contains a basic polyfunctional compound, whereby the rubber layer and the fluororesin layer can be adhered more firmly to each other. A basic polyfunctional compound is a compound that has two or more functional groups having the same or different structures in one molecule and exhibits basicity.

The functional groups in the basic polyfunctional compound are preferably those exhibiting basicity, and are each preferably at least one selected from the group consisting of —NH₂, —NH₃⁺, —NHCOOH, —NHCOO⁻, —N═CR¹R² (wherein R¹ and R² are each independently an organic group having 0 to 12 carbon atoms), —NR³R⁴ (wherein R³ and R⁴ are each independently an organic group having 0 to 12 carbon atoms), —NR³R⁴R⁵ (wherein R³, R⁴, and R⁵ are each independently an organic group having 0 to 12 carbon atoms), and functional groups to be converted into the above functional groups by heat; more preferably at least one selected from the group consisting of —NH₂, —NH₃⁺, —N═CR¹R² (wherein R¹ and R² are defined as described above), and —NR³R⁴R⁵ (wherein R³, R⁴, and R⁵ are defined as described above); still more preferably at least one selected from the group consisting of —NH₂, —NH₃⁺, and —N═CR¹R² (wherein R¹ and R² are defined as described above). The number of functional groups contained in the polyfunctional compound is not limited as long as it is 2 or more, but is preferably 2 to 8, more preferably 2 to 4, still more preferably 2 or 3, and particularly preferably 2.

R¹, R², R³, R⁴, and R⁵ are preferably —H or an organic group having 1 to 12 carbon atoms independently, and is preferably —H or a hydrocarbon group having 1 to 12 carbon atoms. The hydrocarbon group may have one or more carbon-carbon double bonds. The hydrocarbon group preferably has 1 to 8 carbon atoms.

It is preferable that R¹ is —H or —CH₃ and R² is —CH═CHR⁶ (R⁶ is a phenyl group (—C₆H₅), a benzyl group (—CH₂—C₆H₅), or —H), and it is more preferable that R¹ is —H and R² is —CH═CH—C₆H₅.

Examples of the basic polyfunctional compound include ethylenediamine, propanediamine, putrescine, cadaverine, hexamethylenediamine, heptanediamine, octanediamine, nonanediamine, decanediamine, undecanediamine, dodecanediamine, phenylenediamine, N,N′-dicinnamylidene-1,6-hexamethylenediamine, N,N,N′,N′-tetramethyl-1,6-hexamethylenediamine, N,N′-dimethyl-1,6-hexamethylenediamine, and 6-aminohexylcarbamic acid.

The basic polyfunctional compound contains at least two nitrogen atoms in the molecule and the nitrogen-nitrogen interatomic distance is preferably 5.70 A or more. The nitrogen-nitrogen interatomic distance is more preferably 6.30 A or more, still more preferably 7.60 A or more, particularly preferably 8.60 Å or more. A wide nitrogen-nitrogen interatomic distance can lead to better flexibility of the basic polyfunctional compound, resulting in easy crosslinking.

The nitrogen-nitrogen interatomic distance is calculated in accordance with the following method. That is, the structural optimization of each base is calculated using the density functional theory (program: Gaussian03, density functional: B3LYP, basis function: 6-31G*).

In order to achieve adhesion of the rubber layer and the fluororesin layer, the basic polyfunctional compound is preferably at least one selected from the group consisting of N,N′-dicinnamylidene-1,6-hexamethylene diamine and NH₂—(CH₂)ₙ—NH₂ (wherein, n is 5 to 12), and more preferably at least one selected from the group consisting of hexamethylene diamine and N,N′-dicinnamylidene-1,6-hexamethylene diamine.

In the rubber composition, the content of the basic polyfunctional compound is preferably, based on 100 parts by mass of the rubber, 0.1 to 10 parts by mass, more preferably 1.0 part by mass or more, still more preferably 2.0 parts by mass or more, and more preferably 7.0 parts by mass or less, still more preferably 5.0 parts by mass or less, since the rubber layer and the fluororesin layer adhere more firmly to each other.

### (Polytetrafluoroethylene)

The rubber composition preferably further contains polytetrafluoroethylene (PTFE), since the rubber layer and the fluororesin layer can be adhered more firmly to each other.

The specific surface area of PTFE is preferably less than 8 m²/g, more preferably 6.0 m²/g or less, still more preferably 4.0 m²/g or less, particularly preferably 3.0 m²/g or less, and preferably 0.5 m²/g or more, more preferably 1.0 m²/g or more, since the rubber layer and the fluororesin layer can be adhered more firmly to each other.

The specific surface area of PTFE is measured by the BET method using a surface analyzer (trade name: BELSORP-mini II, manufactured by Microtrac BEL Corp.), using a mixed gas of 30% nitrogen and 70% helium as a carrier gas and using liquid nitrogen for cooling.

It is preferable that PTFE is melt-fabricable. The melt viscosity of PTFE at 380° C. is preferably 1×10¹ to 7×10⁵ Pa·s.

A PTFE having a melt viscosity within the above range has a low-molecular weight, and is, for example, a PTFE having a number-average molecular weight of 600,000 or less. A “High-molecular-weight PTFE” having a number-average molecular weight of more than 600,000 exhibits fibrillability distinctive of PTFE (see, for example, Japanese Patent Laid-Open No. 10-147617). A high-molecular-weight PTFE has a high melt viscosity and is non melt-fabricable. It is preferable that the PTFE contained in the rubber layer does not exhibit fibrillability to the extent that paste extrusion forming is possible. The melt viscosity and number-average molecular weight of PTFE can be adjusted by adjusting the polymerization conditions of TFE when producing PTFE or by irradiating the PTFE with an electron beam.

The melt viscosity is a value measured by pre-heating a 2-g sample at 380° C. for 5 minutes and keeping it at the above temperature under a load of 0.7 MPa using a flow tester (Shimadzu Corporation) and a 24-8L die in accordance with ASTM D 1238. Each of the number-average molecular weights is a value calculated from the melt viscosity measured in the above manner.

The apparent density of PTFE is preferably 0.15 to 0.80 g/cm³, and more preferably 0.25 g/cm³ or more, and still more preferably 0.55 g/cm³ or less.

The apparent density can be measured in conformity with JIS K 6891.

The average particle size of PTFE is preferably 0.01 to 1,000 μm, more preferably 0.1 μm or more, still more preferably 0.3 μm or more, particularly preferably 0.5 μm or more, and more preferably 100 μm or less, still more preferably 50 μm or less, particularly preferably 20 μm or less.

The average particle size is considered to be a particle size corresponding to a value of 50% of the cumulative volume in the particle size distribution determined using a laser diffraction type particle size distribution measurement apparatus (for example, manufactured by Japan Laser Corporation) at a pressure of 0.1 MPa and a measurement time of three seconds without cascade.

The melting point of PTFE is preferably 324 to 333° C.

The melting point of PTFE is determined by temperature calibration using a differential scanning calorimeter RDC220 (DSC) manufactured by SII NanoTechnology Inc, using indium and lead as standard samples in advance, placing about 3 mg of PTFE powder in an aluminum pan (crimp container), heating the temperature range of 250 to 380° C. at 10° C./min under an air flow of 200 ml/min, performing differential scanning calorimetry, and using the minimum point of quantity of heat of melting in the above range as the melting point.

The melt flow rate (MFR) of PTFE at 372° C. (load 1.2 kg) is preferably 0.01 to 10 g/10 minutes.

The MFR can be determined by measuring the weight (g) of the polymer flowed out of a nozzle (diameter: 2 mm, length: 8 mm) per unit time (10 minutes) at 372° C. under a load of 1.2 kg using a melt indexer (for example, manufactured by Toyo Seiki Seisaku-sho, Ltd.).

The burning loss (ignition loss) of the PTFE at 300° C. is preferably 0.05% by mass or more, more preferably 0.09% by mass or more, still more preferably 0.15% by mass or more, and particularly preferably 0.30% by mass or more.

The burning loss can be specified by heating PTFE (sample) at 300° C. for 2 hours, measuring the mass of the sample after heating, and calculating the proportion of the weight loss of the sample after heating to the mass of the sample before heating.

The PTFE may be a TFE homopolymer, or may be a modified PTFE containing a TFE unit and a modifying monomer unit copolymerizable with TFE.

In the modified PTFE, the content of the modifying monomer unit copolymerizable with TFE is preferably from 0.01 to 1% by mass, more preferably from 0.01 to 0.5% by mass, and most preferably from 0.03 to 0.3% by mass, based on all monomer units.

In the present disclosure, the “modifying monomer unit” means a portion of the molecular structure of the modified PTFE as a part derived from the modifying monomer, and the “all monomer units” means all the portions derived from monomers in the molecular structure of the modified PTFE. The content of the modifying monomer unit is measured by infrared spectroscopy or NMR (nuclear magnetic resonance).

The modifying monomer in the modified PTFE may be any modifying monomer copolymerizable with TFE, and examples thereof include, but are not limited to, perfluoroolefins such as hexafluoropropylene (HFP); chlorofluoroolefins such as chlorotrifluoroethylene (CTFE); hydrogen-containing fluoroolefins such as trifluoroethylene and vinylidene fluoride (VDF); perfluorovinyl ethers; perfluoroalkylethylenes; and ethylene. The modifying monomer to be used may be one kind or a plurality of kinds.

Examples of the perfluorovinyl ether include, but are not limited to, a perfluoro unsaturated compound represented by the general formula (1):

CF₂═CF—ORf (I)
wherein Rf represents a perfluoroorganic group. The “perfluoroorganic group” as used herein means an organic group in which all hydrogen atoms bonded to the carbon atoms are replaced by fluorine atoms. The perfluoroorganic group optionally has ether oxygen.

Examples of the perfluorovinyl ether include perfluoro(alkyl vinyl ether) (PAVE) in which Rf represents a perfluoroalkyl group having 1 to 10 carbon atoms in the general formula (I). The perfluoroalkyl group preferably has 1 to 5 carbon atoms.

Examples of the perfluoroalkyl group in PAVE include a perfluoromethyl group, a perfluoroethyl group, a perfluoropropyl group, a perfluorobutyl group, a perfluoropentyl group, and a perfluorohexyl group, and preferred is perfluoropropyl vinyl ether (PPVE) of which the perfluoroalkyl group is a perfluoropropyl group.

Examples of the perfluorovinyl ether further include those represented by the general formula (I) in which Rf is a perfluoro(alkoxyalkyl) group having 4 to 9 carbon atoms; those in which Rf is a group represented by the following formula:

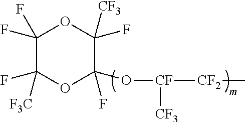

wherein m represents 0 or an integer of 1 to 4; and those in which Rf is a group represented by the following formula:

CF₃CF₂CF₂—(O—CF(CF₃)—CF₂)ₙ—
wherein n is an integer of 1 to 4.

Examples of the perfluoroalkylethylene include, but are not limited to, perfluorobutyl ethylene (PFBE), perfluorohexyl ethylene, and perfluorooctyl ethylene.

The modifying monomer in the modified PTFE is preferably at least one monomer selected from the group consisting of HFP, CTFE, VDF, PPVE, PFBE, and ethylene, and more preferably HFP.

The PTFE is preferably a modified PTFE, and more preferably a modified PTFE containing a TFE unit and a polymerized unit derived from HFP (HFP unit).

The content of PTFE in the rubber composition is preferably, based on 100 parts by mass of the rubber, 0.5 to 100 parts by mass, more preferably 10 parts by mass or more, still more preferably 20 parts by mass or more, and more preferably 80 parts by mass or less, still more preferably 60 parts by mass or less, particularly preferably 45 parts by mass or less, since the conductivity of the rubber layer is suitably adjusted and the rubber layer and the fluororesin layer adhere more firmly to each other.

### (Silica)

The rubber composition preferably further contains silica, since the rubber layer and the fluororesin layer can be adhered more firmly to each other.

As the silica, basic silica and acidic silica can be used, and from the viewpoint of adhesiveness, basic silica is preferably used. Examples of the basic silica include Carplex 1120 (manufactured by DSL Japan Co., Ltd.), Sidistar R300 (manufactured by Elkem Corporation), Silene732D (manufactured by PPG Industries), and Inhibisi175 (manufactured by PPG Industries). Further, since the rubber layer and the fluororesin layer adhere more firmly, silica having a large average particle size is preferably used. Examples of silica having a large average particle size include Sidistar R300 (manufactured by Elkem Corporation), Sidistar T120U (manufactured by Elkem Corporation), ADMAFINE series (manufactured by Admatechs), and Excelica series (manufactured by Tokuyama Corporation).

The average value of products of “(particle size)×(roundness)” of silica particles is preferably 17.5 nm or more, more preferably 20.0 nm or more, still more preferably 30.0 nm or more, particularly preferably 50.0 nm or more, most preferably 70.0 nm or more, and preferably 500 μm or less, more preferably 300 μm or less, still more preferably 100 μm or less, particularly preferably 50 μm or less, most preferably 30 μm or less.

The average particle size of silica is preferably 25.0 nm or more, more preferably 30.0 nm or more, still more preferably 40.0 nm or more, particularly preferably 60.0 nm or more, most preferably 80.0 nm or more, and preferably 500 μm or less, more preferably 300 μm or less, still more preferably 100 μm or less.

The average roundness of silica is preferably 0.80 or more, and more preferably 0.85 or more. The upper limit of theoretical roundness is 1.

The “average particle size” of silica can be measured by allowing silica particles to be adsorbed on a polyethylene terephthalate (PET) film, coating the film using platinum sputtering, and performing the image analysis of the scanning electron microscope (SEM) image of the silica particles in the coated film. In the image analysis, the SEM image is processed for noise elimination and binarization, 100 particles are then randomly selected from the processed image, and the average size of silica particles observed in the two-dimensional image having a depth of field of 1 to 2 μm is measured. Here, with respect to a circular two-dimensional shape, the “size” corresponds to the diameter (not radius). With respect to a non-circular two-dimensional shape having an area S, the “size” can be obtained by taking the square root of (4×S/π) that is considered to correspond to the diameter of a circle.

The “average roundness” of silica can be measured by allowing silica particles to be adsorbed on a PET film, coating the film using platinum sputtering, and performing the image analysis of the SEM image of the silica particles in the coated film. In the image analysis, the SEM image is processed for noise elimination and binarization, 100 particles are then randomly selected from the processed image, and the average roundness of silica particles observed in the two-dimensional image having a depth of field of 1 to 2 μm is measured. The value of the “roundness” of the two-dimensional shape is defined as follows.

(Roundness)=4π×(area of binary two dimensional cross-section image of silica particle)/(circumference of circle of binary two dimensional cross-section image of silica particle)2

As the value of roundness approaches 1, the corresponding two-dimensional shape is close to a true circle.

The “average value of products of “(particle size)×(roundness)”” of silica can be measured by allowing silica particles to be adsorbed on a polyethylene terephthalate (PET) film, coating the film using platinum sputtering, and performing the image analysis of the scanning electron microscope (SEM) image of the silica particles in the coated film. In the image analysis, the SEM image is processed for noise elimination and binarization, 100 particles are then randomly selected from the processed image, and an average of products of “(particle size)×(roundness)” of silica particles observed in the two-dimensional image having a depth of field of 1 to 2 μm is measured.

In the measurement of the above average particle size, average roundness, and average value of products of “(particle size)×(roundness)”, an agglomerate may be counted as one large particle by mistake, or gray shadow in the particle image may not be recognized as a part of a particle, in some cases. Thus, only silica particles having a clear outline are selected as representative samples, and silica particles overlapping each other are ignored.

The content of silica in the rubber composition is preferably, based on 100 parts by mass of the rubber, 5 to 100 parts by mass, more preferably 10 parts by mass or more, still more preferably 15 parts by mass or more, and more preferably 50 parts by mass or less, still more preferably 30 parts by mass or less, since the conductivity of the rubber layer is suitably adjusted and the rubber layer and the fluororesin layer adhere more firmly to each other.

### (Crosslinking Agent)

The rubber composition preferably further contains a crosslinking agent, since the rubber layer and the fluororesin layer can be adhered more firmly to each other. As the crosslinking agent, a peroxide crosslinking agent or the like can be selected according to the purpose. The rubber composition preferably further contains a peroxide crosslinking agent.

Examples of the peroxide crosslinking agent include, but are not limited to, organic peroxides. The organic peroxides are preferably those which easily generate peroxy radicals in the presence of heat or a redox system, and examples thereof include 1,1-bis(t-butylperoxy)-3,5,5-trimethylcyclohexane, 2,5-dimethylhexane-2,5-dihydroxyperoxide, di-t-butyl peroxide, t-butyl cumyl peroxide, dicumyl peroxide, α,α′-bis(t-butylperoxy)-p-diisopropylbenzene, 2,5-dimethyl-2,5-di(t-butylperoxy) hexane, 2,5-dimethyl-2,5-di(t-butylperoxy) hexyne-3, benzoyl peroxide, t-butylperoxybenzene, 2,5-dimethyl-2,5-di(benzoylperoxy) hexane, t-butylperoxymaleic acid, and t-butylperoxy isopropyl carbonate. More preferred are dialkyl compounds.

The amount of peroxide crosslinking agent used is usually selected as appropriate in accordance with factors such as the amount of active —O—O— and the decomposition temperature. The content of the peroxide crosslinking agent in the rubber composition is usually 0.1 to 15 parts by mass, preferably 0.3 parts by mass or more, more preferably 1.0 part by mass or more, and preferably 5 parts by mass or less, more preferably 3 parts by mass or less, based on 100 parts by mass of the rubber.

### (Crosslinking Aid)

When the crosslinking agent is a peroxide crosslinking agent, the rubber composition preferably contains a crosslinking aid. Examples of the crosslinking aid include triallyl cyanurate, trimethallyl isocyanurate, triallyl isocyanurate (TRIC), triacrylformal, triallyl trimellitate, N,N′-m-phenylene bismaleimide, dipropargyl terephthalate, diallyl phthalate, tetraallyl terephthalate amide, triallyl phosphate, bismaleimide, fluorinated triallyl isocyanurate (1,3,5-tris(2,3,3-trifluoro-2-propenyl)-1,3,5-triazine-2,4,6-trione), tris(diallylamine)-S-triazine, triallyl phosphite, N,N-diallylacrylamide, 1,6-divinyldodecafluorohexane, hexaallyl phosphoramide, N, N,N′,N′-tetraallyl phthalamide, N,N,N′,N′-tetraallyl malonamide, trivinyl isocyanurate, 2,4,6-trivinyl methyl trisiloxane, tri (5-norbornene-2-methylene) cyanurate, and triallyl phosphite. In order to achieve good crosslinkability and good physical properties of the resulting crosslinked product, triallyl isocyanurate (TAIC) is preferred.

The content of the crosslinking aid in the rubber composition is preferably 0.1 to 10 parts by mass, more preferably 1.0 parts by mass or more, still more preferably 7 parts by mass or less, and still further preferably 5 parts by mass or less, based on 100 parts by mass of the rubber.

### (Other Components in Rubber Composition)

The rubber composition may further contain, as an acid acceptor or a compounding agent for improving the adhesion between the rubber layer and the fluororesin layer, at least one compound selected from the group consisting of a metal oxide, a metal hydroxide, a weak acid salt of alkali metal, and a weak acid salt of alkaline earth metal.

Examples of the metal oxide, metal hydroxide, weak acid salt of alkali metal, and weak acid salt of alkaline earth metal include: oxides, hydroxides, carbonates, carboxylates, silicates, borates, and phosphites of metals in the group (II) of the periodic table; and oxides, basic carbonates, basic carboxylates, basic phosphites, and basic sulfites of metals in the group (IV) of the periodic table.

Specific examples of the metal oxide, metal hydroxide, weak acid salt of alkali metal, and weak acid salt of alkaline earth metal include magnesium oxide, zinc oxide, magnesium hydroxide, barium hydroxide, magnesium carbonate, barium carbonate, calcium oxide (quicklime), calcium hydroxide (slaked lime), calcium carbonate, calcium silicate, calcium stearate, zinc stearate, calcium phthalate, calcium phosphite, tin oxide, and basic tin phosphite.

In the case of using the peroxide crosslinking agent as the crosslinking agent, the content of the metal oxide, metal hydroxide, weak acid salt of alkali metal, and weak acid salt of alkaline earth metal is preferably, based on 100 parts by mass of the rubber, 5 parts by mass or less, more preferably 3 parts by mass or less and still more preferably not contained from the viewpoint of acid resistance.

The rubber composition may contain common additives to be blended into rubber compositions as appropriate, and examples thereof include various additives such as a filler, processing aid, plasticizer, colorant, stabilizer, adhesive aid, acid acceptor, mold release agent, conductivity-imparting agent, thermal-conductivity-imparting agent, surface non-adhesive agent, flexibility-imparting agent, heat resistance improver, and flame retarder. One or more of common crosslinking agents and crosslinking accelerators other than those mentioned above may also be contained. In one embodiment, the rubber composition or the rubber layer contains no carbon fibril.

### (B) Fluororesin Layer

The fluororesin layer is a layer formed of fluororesin. In the present disclosure, the fluororesin is a partially crystalline fluoropolymer and is fluoroplastic. The fluororesin has a melting point and thermoplasticity.

The fluororesin that forms the fluororesin layer of the laminate of the present disclosure is melt-fabricable fluororesin. The term “melt-fabricable” means that a polymer can be melted and processed using a conventional processing device such as an extruder and an injection molding machine. Therefore, melt-fabricable fluororesin usually has a melt flow rate measured by the measurement method described below of 0.01 to 500 g/10 min.

The fluororesin preferably has a low fuel permeability coefficient. The fuel permeability coefficient of the fluororesin is preferably 2.0 g·mm/m²/day or less, more preferably 1.5 g·mm/m²/day or less, still more preferably 0.8 g·mm/m²/day or less, particularly preferably 0.55 g·mm/m²/day or less, and most preferably 0.5 g·mm/m²/day or less. Since the fluororesin layer contains a fluororesin having a fuel permeability coefficient within the above range, the fluororesin layer exhibits excellent low fuel permeability, and the laminate can be suitably used as a fuel hose or the like.

The fuel permeability coefficient is a value calculated from the mass change determined as follows. Specifically, a SUS316 fuel permeability coefficient measurement cup having an inner diameter of 40 mmϕ and a height of 20 mm is charged with 18 mL of an isooctane-toluene-ethanol solvent mixture in which isooctane, toluene, and ethanol are mixed at a ratio by volume of 45:45:10; a fluororesin sheet (diameter: 45 mm, thickness: 120 μm) is produced from the measurement target resin by the following method and is put into the measurement cup; and then the mass change is determined at 60° C.

### (Method for Producing Fluororesin Sheet)

Resin pellets are put into a mold having a diameter of 120 mm. The workpiece is mounted on a press heated up to 300° C. and the pellets are melt-pressed at a pressure of about 2.9 MPa, whereby a fluororesin sheet having a thickness of 0.12 mm is obtained. This sheet is then processed to have a diameter of 45 mm and a thickness of 120 μm.

In order to provide a laminate having excellently low fuel permeability, the fluororesin is preferably at least one selected from the group consisting of polychlorotrifluoroethylene (PCTFE), a CTFE-based copolymer, and a TFE/HFP/VdF copolymer; in order to provide a laminate having more excellent adhesion between the rubber layer and the fluororesin layer and excellent low fuel permeability, the fluororesin is more preferably at least one selected from the group consisting of a CTFE-based copolymer and a TFE/HFP/VdF copolymer: and in order to provide a laminate having more excellent adhesion between the rubber layer and the fluororesin layer and excellent low fuel permeability and flexibility, the fluororesin is still more preferably a CTFE-based copolymer.

A lower VdF content leads to lower fuel permeability, and thus the TFE/HFP/VdF copolymer preferably satisfies a TFE/HFP/VdF copolymerization ratio (mol % ratio) of 75 to 95/0.1 to 10/0.1 to 19, more preferably 77 to 95/1 to 8/1 to 17 (molar ratio), still more preferably 77 to 95/2 to 8/2 to 15.5 (molar ratio), most preferably 79 to 90/5 to 8/5 to 15 (molar ratio). The TFE/HFP/VdF copolymer may contain 0 to 20 mol % of a different monomer. The different monomer may be at least one monomer selected from the group consisting of fluorine-containing monomers such as perfluoro(methyl vinyl ether), perfluoro(ethyl vinyl ether), perfluoro(propyl vinyl ether), chlorotrifluoroethylene, 2-chloropentafluoropropene, perfluorinated vinyl ether (e.g., perfluoroalkoxy vinyl ethers such as CF₃OCF₂CF₂CF₂OCF=CF₂) perfluoroalkyl vinyl ether, perfluoro-1,3-butadiene, trifluoroethylene, hexafluoroisobutene, vinyl fluoride, ethylene, propylene, and alkyl vinyl ether. Preferred are perfluoro(methyl vinyl ether), perfluoro(ethyl vinyl ether), and perfluoro(propyl vinyl ether).

PCTFE is a homopolymer of chlorotrifluoroethylene.

The CTFE-based copolymer preferably contains a copolymerized unit (CTFE unit) derived from CTFE and a copolymerized unit derived from at least one monomer selected from the group consisting of TFE, HFP, PAVE, VdF, vinyl fluoride, hexafluoroisobutene, monomers represented by the formula: CH₂═CX³(CF₂)ₙX⁴ (wherein X³ is H or F; X⁴ is H, F, or Cl; and n is an integer of 1 to 10), ethylene, propylene, 1-butene, 2-butene, vinyl chloride, and vinylidene chloride. The CTFE-based copolymer is more preferably a perhalopolymer.

The CTFE-based copolymer more preferably contains a CTFE unit and a copolymerized unit derived from at least one monomer selected from the group consisting of TFE, HFP, and PAVE, still more preferably consists substantially only of these copolymerized units. From the viewpoint of low fuel permeability, the CTFE-based copolymer is preferably free from a monomer containing a CH bond, such as ethylene, vinylidene fluoride, and vinyl fluoride.

A perhalopolymer free from a monomer having a CH bond is usually difficult to adhere to a rubber (particularly, fluoroelastomer), but according to the configuration of the present disclosure, even when the fluororesin layer contains a perhalopolymer, interlayer adhesion between the rubber layer and the fluororesin layer is strong.

The CTFE-based copolymer preferably has 10 to 90 mol % of CTFE units based on the total monomer units.

The CTFE-based copolymer particularly preferably contains a CTFE unit, a TFE unit, and a monomer (α) unit derived from a monomer (α) copolymerizable therewith.

The “CTFE unit” and the “TFE unit” are respectively a moiety (—CFCl—CF₂—) derived from CTFE and a moiety (—CF₂—CF₂—) derived from TFE in the molecular structure of the CTFE-based copolymer, and the “monomer (α) unit” is similarly a moiety formed by addition of a monomer (α) in the molecular structure of the CTFE-based copolymer.

The monomer (α) may be any monomer copolymerizable with CTFE and TFE. Examples thereof include ethylene (Et), vinylidene fluoride (VdF), PAVE represented by CF₂═CF—ORf² (wherein Rf² is a perfluoroalkyl group having 1 to 8 carbon atoms), vinyl monomers represented by CX⁵X⁶═CX⁷(CF₂)ₙX⁸ (wherein X⁵, X⁶, and X⁷ are the same as or different from each other, and are each a hydrogen atom or a fluorine atom; X⁸ is a hydrogen atom, a fluorine atom, or a chlorine atom; and n is an integer of 1 to 10), and alkyl perfluorovinyl ether derivatives represented by CF₂═CF—O—Rf³ (wherein Rf³ is a perfluoroalkyl group having 1 to 5 carbon atoms).

Preferred among the alkyl perfluorovinyl ether derivatives are those in which Rf³ is a perfluoroalkyl group having 1 to 3 carbon atoms, and more preferred is CF₂═CF—OCF₂—CF₂CF₃ (PPVE).

The monomer (α) is preferably at least one selected from the group consisting of PAVE, the vinyl monomers, and the alkyl perfluorovinyl ether derivatives, more preferably at least one selected from the group consisting of PAVE and HFP, particularly preferably PAVE.

For the ratio of the CTFE unit and the TFE unit in the CTFE-based copolymer, the CTFE unit represents 15 to 90 molo and the TFE unit represents 85 to 10 mol %, more preferably the CTFE unit represents 20 to 90 mol % and the TFE unit represents 80 to 10 mol %. Also preferred is a structure in which the CTFE unit represents 15 to 25 mol % and the TFE unit represents 85 to 75 mol %.

The CTFE-based copolymer preferably satisfies that the CTFE unit and the TFE unit represent 90 to 99.9 mol % in total and the monomer (α) unit represents 0.1 to 10 mol %. Less than 0.1 mol % of the monomer (α) unit may cause poor formability, environmental stress cracking resistance, and fuel crack resistance. More than 10 mol % thereof tends to cause insufficiently low fuel permeability, poor heat resistance, and poor mechanical properties.

From the viewpoint of low fuel permeability and adhesiveness, the fluororesin is more preferably at least one selected from the group consisting of PCTFE, CTFE/TFE/PAVE copolymers and TFE/HFP/VdF copolymers, still more preferably at least one selected from the group consisting of CTFE/TFE/PAVE copolymers and TFE/HFP/VdF copolymers, and particularly preferably CTFE/TFE/PAVE copolymers.

Examples of the PAVE in the CTFE/TFE/PAVE copolymer include perfluoro(methyl vinyl ether) (PMVE), perfluoro(ethyl vinyl ether) (PEVE), perfluoro(propyl vinyl ether) (PPVE), and perfluoro(butyl vinyl ether). Preferred among these is at least one selected from the group consisting of PMVE, PEVE, and PPVE.

In the CTFE/TFE/PAVE copolymer, the PAVE unit preferably represents 0.5 mol % or more and 5 mol % or less of all monomer units.

The constituent units such as a CTFE unit are values obtainable by 19F-NMR analysis.

The fluororesin may contain at least one reactive functional group selected from the group consisting of a carbonyl group, a hydroxyl group, a heterocyclic group, and an amino group introduced into a side chain and/or an end of the main chain of the polymer.

The term “carbonyl group” as used herein means a divalent carbon group containing a carbon-oxygen double bond, which is typified by —C(═O)—. Examples of the reactive functional group containing a carbonyl group include, but are not limited to, those containing a carbonyl group as a moiety of the chemical structure, such as a carbonate group, a carboxylic acid halide group (halogenoformyl group), a formyl group, a carboxyl group, an ester bond (—C(═O)O—), an acid anhydride bond (—C(═O)O—C(═O)—), an isocyanate group, an amide group, an imide group (—C(═O)—NH—C(═O)—), a urethane bond (—NH—C(═O)O—), a carbamoyl group (NH₂—C(═O)—), a carbamoyloxy group (NH₂—C(═O)O—), a ureido group (NH₂—C(═O)—NH—), and an oxamoyl group (NH₂—C(═O)—C(═O)—).

In groups such as an amide group, an imide group, a urethane bond, a carbamoyl group, a carbamoyloxy group, a ureido group, and an oxamoyl group, a hydrogen atom binding to the nitrogen atom thereof may be replaced by a hydrocarbon group such as an alkyl group.

In order to achieve easy introduction and to allow the fluororesin to have moderate heat resistance and good adhesion at relatively low temperatures, the reactive functional group is preferably an amide group, a carbamoyl group, a hydroxyl group, a carboxyl group, a carbonate group, a carboxylic acid halide group, or an acid anhydride bond, more preferably an amide group, a carbamoyl group, a hydroxyl group, a carbonate group, a carboxylic acid halide group, or an acid anhydride bond.

The fluororesin may be obtainable by any conventionally known polymerization method such as suspension polymerization, solution polymerization, emulsion polymerization, or bulk polymerization. In the polymerization, the conditions such as the temperature and the pressure, a polymerization initiator and other additives may appropriately be selected in accordance with the compositional feature and amount of the fluororesin.

The fluororesin preferably has a melting point of 160° C. to 270° C., although not limited thereto. The melting point of the fluororesin is defined as the temperature corresponding to the maximum value on a heat-of-fusion curve obtained by increasing the temperature at a rate of 10° C./min using a DSC device (manufactured by Seiko Instruments Inc.).

The fluororesin preferably has a molecular weight that allows the resulting laminate to exert characteristics such as good mechanical properties and low fuel permeability. For example, with the melt flow rate (MFR) taken as an indicator of the molecular weight, the MFR is preferably 0.5 to 100 g/10 min at any temperature within the range of about 230° C. to 350° C., which is a common forming temperature range for fluororesins. The MFR is more preferably 1 to 50 g/10 min, still more preferably 2 to 35 g/10 min. For example, for the fluororesin that is PCTFE, a CTFE-based copolymer, or a TFE/HFP/VdF copolymer, the MFR is measured at 297° C.

The MFR can be determined by measuring the weight (g) of the polymer flowed out of a nozzle (diameter: 2 mm, length: 8 mm) per unit time (10 minutes) at 297° C. under a load of 5 kg using a melt indexer (manufactured by Toyo Seiki Seisaku-sho, Ltd.).

The fluororesin layer may contain one of these fluororesins, or may contain two or more of these fluororesins.

The fluororesin can lead to better chemical resistance and lower fuel permeability when it is a perhalopolymer. The perhalopolymer is a polymer in which every carbon atom constituting the main chain of the polymer is coupled with a halogen atom.

The fluororesin layer may further contain any of various fillers such as inorganic powder, glass fiber, carbon powder, carbon fiber, and metal oxides in accordance with the purpose and application thereof to the extent that does not impair the performance thereof.

For example, in order to further reduce fuel permeability, a smectite-based layered viscosity mineral such as montmorillonite, biderite, saponite, nontronite, hectorite, sauconite, stevensite, or a microlayered mineral having a high aspect ratio such as mica may be added.

### (Laminated Body)

The thickness of the rubber layer is not limited, but is preferably 100 μm or more, for example. The upper limit of the thickness of the rubber layer is, for example, 5000 μm.

The thickness of the fluororesin layer is not limited, but is preferably 10 μm or more, for example. The upper limit of the thickness of the fluororesin layer is, for example, 1000 μm.

The adhesive strength between the rubber layer and the fluororesin layer in the laminate is preferably 3 N/cm or more, more preferably 4 N/cm or more, still more preferably 5 N/cm or more, and particularly preferably 6 N/cm or more.

The adhesive strength is determined as follows. The laminate is cut into three strips having a width of 10 mm and a length of 40 mm, whereby test pieces are prepared. For each of these test pieces, in order to determine the adhesive strength of the adhesion surface alone without the adhesive strength of the interface between the rubber layer and the fluororesin layer, the interface between the rubber layer and the fluororesin layer is slowly stretched by hand once to increase the grip section by 2 to 3 mm. Then, the test piece is subjected to a peeling test at 25° C. and a tensile rate of 50 mm/min using an autograph (AGS-J 5 kN, manufactured by Shimadzu Corporation) in conformity with JIS K 6256 (Determination of adhesion strength for vulcanized rubber). The mode of peeling is then observed. The value thereby obtained is defined as the adhesive strength.

In the laminate of the present disclosure, the rubber layer and the fluororesin layer are preferably directly adhered to each other, and more preferably directly crosslinked and adhered to each other. Such a laminate can be obtained by laminating an uncrosslinked rubber layer and a fluororesin layer and then subjecting them to crosslinking treatment. The laminate of the present disclosure may be a crosslinked laminate.

The crosslinking treatment can be performed by a conventionally known crosslinking method under conventionally known crosslinking conditions for rubber compositions. Examples thereof include a method of crosslinking an uncrosslinked laminate for a long time, and a method of heating an uncrosslinked laminate for a relatively short time as a pretreatment (crosslinking also occurs), and then crosslinking the workpiece for a long time. Preferred between them is a method of heating an uncrosslinked laminate for a relatively short time as a pretreatment, and then crosslinking the workpiece for a long time. This is because the pretreatment can easily lead to adhesion between the rubber layer and the fluororesin layer and the pretreatment allows the rubber layer to be crosslinked already and to have a stable shape, which can provide various choices of a method of holding the laminate during the following crosslinking.

The crosslinking treatment may be performed under any usual conditions. Preferably, the crosslinking is performed at 140° C. to 180° C. for 2 to 80 minutes using steam, press, oven, air bath, infrared radiation, microwaves, lead-covered crosslinking, or the like. The crosslinking is more preferably performed at 150° C. to 170° C. for 5 to 60 minutes. The crosslinking treatment may be divided into a first crosslinking and a second crosslinking.

The laminate of the present disclosure can be suitably produced by a method for producing a laminate including, for example, a step of mixing rubber and carbon black to obtain a rubber composition, a step of laminating an uncrosslinked rubber layer obtained by forming the rubber composition and a fluororesin layer, and a step of performing a crosslinking treatment on the laminated uncrosslinked rubber layer and fluororesin layer. In the above production method, the conditions of the crosslinking treatment are the same as those described above.

The mixing of rubber and carbon black can be performed, for example, by kneading rubber and carbon black using a commonly used rubber kneading device.

Examples of the rubber kneading device include rolls, kneaders, Banbury mixers, internal mixers, and twin-screw extruders.

In the mixing, in addition to rubber and carbon black, if necessary, a further additive such as a basic polyfunctional compound, polytetrafluoroethylene, silica, a crosslinking agent, or a crosslinking aid may be mixed together.

The mixing temperature is, for example, 20 to 200° C. The mixing time is, for example, 2 to 80 minutes.

The uncrosslinked rubber layer and the fluororesin layer may be laminated by any of a method in which the uncrosslinked rubber layer and the fluororesin layer are separately formed and then laminated by means of pressure bonding or the like, a method in which the uncrosslinked rubber layer and the fluororesin layer are simultaneously formed and laminated, and a method in which the fluororesin is applied to the uncrosslinked rubber layer to form the fluororesin layer.

In the method in which the uncrosslinked rubber layer and the fluororesin layer are separately formed and then laminated by means of pressure bonding or the like, a method for forming the rubber composition alone and a method for forming the fluororesin alone may be adopted.

For the forming of the uncrosslinked rubber layer, the formed article having any shape such as a sheet or a tube may be produced by using heat compression molding, transfer molding, extrusion forming, injection molding, calender forming, or coating of the rubber composition. The forming may be performed using any forming device usually used for polymers, such as an injection molding device, a blow forming device, an extrusion forming device, or any coating device. They can provide a laminate having any shape such as a sheet or a tube. In order to achieve excellent productivity, extrusion forming is preferred.

For the forming of the fluororesin layer, the formed article having any shape such as a sheet or a tube may be produced by using compression molding, extrusion forming, injection molding, calender forming, or coating (including powder coating) of the fluororesin. The forming may be performed using any forming device usually used for polymers, such as an injection molding device, a blow forming device, an extrusion forming device, or any coating device. They can provide a laminate having any shape such as a sheet or a tube. In order to achieve excellent productivity, extrusion forming is preferred.

The method in which the uncrosslinked rubber layer and the fluororesin layer are formed and laminated simultaneously may be a method in which a rubber composition to form the rubber layer and a fluororesin to form the fluororesin layer are formed and laminated simultaneously by a technique such as multilayer compression molding, multilayer transfer forming, multilayer extrusion forming, multilayer injection molding, or doubling. This method enables simultaneous laminating of the uncrosslinked rubber layer which is an uncrosslinked formed body and the fluororesin layer. Thus, the method needs no step of closely adhering the uncrosslinked rubber layer and the fluororesin layer and is suitable to achieve firm adhesion in the following crosslinking. If the close adhesion is insufficient, a close-adhesion step such as wrapping may be performed. In order to achieve excellent productivity, multilayer extrusion forming is preferred.

### (Layer Structure of Laminate)

The laminate of the present disclosure includes the above-mentioned rubber layer (A) and the above-mentioned fluororesin layer (B).

The laminate of the present disclosure may have a bilayer structure of the rubber layer (A) and the fluororesin layer (B), may have a structure in which the rubber layer (A) is laminated on each side of the fluororesin layer (B), or may have a structure in which the fluororesin layer (B) is laminated on each side of the rubber layer (A).

For example, the laminated product may have a trilayer structure of rubber layer (A)-fluororesin layer (B)-rubber layer (A) or of fluororesin layer (B)-rubber layer (A)-fluororesin layer (B).

The laminated product may have a multilayer structure of three or more layers including a polymer layer (C) other than the rubber layer (A) and the fluororesin layer (B) bonded together, or may be a structure including a polymer layer (D) on one or each side of a trilayer structure including a polymer layer (C) other than the rubber layer (A) and the fluororesin layer (B) adhered together. The polymer layer (C) and the polymer layer (D) may be the same as or different from each other.

The laminate of the present disclosure may include a polymer layer (C) on one or each side of a trilayer structure of rubber layer (A)-fluororesin layer (B)-rubber layer (A).

The polymer layers (C) and (D) may be respectively rubber layers (C1) or (D1) other than the rubber layer (A). The rubber layers (C1) and (D1) may be respectively non-fluoroelastomer layers (C1a) or (D1a) formed from a non-fluoroelastomer. A non-fluoroelastomer is preferred because it has good low-temperature resistance and excellent cost efficiency. The non-fluoroelastomer layer (C1a) and the non-fluoroelastomer layer (D1a) may be formed from the same non-fluoroelastomer, or may be formed from different non-fluoroelastomers.

The laminate of the present disclosure may include the layers laminated in the order of rubber layer (A)-fluororesin layer (B)-non-fluoroelastomer layer (C1a).

The laminate of the present disclosure may further include a non-fluoroelastomer layer (D1a) and the layers may be laminated in the order of non-fluoroelastomer layer (D1a)-rubber layer (A)-fluororesin layer (B)-non-fluoroelastomer layer (C1a), in the order of rubber layer (A)-fluororesin layer (B)-non-fluoroelastomer layer (D1a)-non-fluoroelastomer layer (C1a), or in the order of rubber layer (A)-fluororesin layer (B)-non-fluoroelastomer layer (C1a)-non-fluoroelastomer layer (D1a).

Specific examples of the non-fluoroelastomer include diene-based rubber such as acrylonitrile-butadiene rubber (NBR) or hydride thereof (HNBR), styrene-butadiene rubber (SBR), chloroprene rubber (CR), butadiene rubber (BR), natural rubber (NR), and isoprene rubber (IR), ethylene-propylene-termonomer copolymerized rubber, silicone rubber, butyl rubber, epichlorohydrin rubber, acrylic rubber, chlorinated polyethylene (CPE), polyblend of acrylonitrile-butadiene rubber and vinyl chloride (PVC-NBR), ethylene propylene diene rubber (EPDM), and chlorosulfonated polyethylene (CSM). Examples also include rubber obtained by mixing any of these non-fluoroelastomers and fluoroelastomers at any proportion.

In order to achieve good heat resistance, oil resistance, weather resistance, and extrusion formability, the non-fluoroelastomer is preferably a diene-based rubber or epichlorohydrin rubber. It is more preferably NBR, HNBR, or epichlorohydrin rubber. The rubber layer (C1) is preferably formed from NBR, HNBR, or epichlorohydrin rubber.

In order to achieve good weather resistance and cost efficiency, the rubber layer (D1) is preferably formed from acrylonitrile-butadiene rubber, epichlorohydrin rubber, chlorinated polyethylene (CPE), polyblend of acrylonitrile-butadiene rubber and vinyl chloride (PVC-NBR), ethylene propylene diene rubber (EPDM), acrylic rubber, or a mixture of any of these. The uncrosslinked rubber composition to form the rubber layer (C1) or (D1) may also contain a crosslinking agent and any other compounding agents.

Among the above layer structures, the laminate of the present disclosure preferably has a structure such that the rubber layer (A) forms at least one surface of the laminate. In the laminate of the present disclosure, the rubber layer (A) has conductivity and the rubber layer (A) and the fluororesin layer (B) are adhered firmly to each other, so that forming at least one surface of the laminate using the rubber layer (A) can effectively prevent the laminate from charging, while imparting flexibility to the laminate, and the fluororesin layer (B) adhered firmly to the rubber layer (A) can sufficiently impart other properties such as low fuel permeability to the laminate.

Next, the layer structure of the laminate of the present disclosure is described in more detail below.

### (1) Bilayer Structure of Rubber Layer (A)-Fluororesin Layer (B)

This is a basic structure. Conventional structures of this type suffer insufficient bonding between the layers (between the fluoroelastomer layer and the fluororesin layer), and thus stacking of the fluororesin layer (B) and the rubber layer (A) requires surface treatment on the resin side, application of additional adhesive between the layers, fixing of the layers by wrapping a tape-shaped film therearound, or the like, which causes complication of the process. In the present disclosure, crosslinking leads to crosslink bonding, so that chemically firm adhesion between the layers can be achieved without such a complicated process.

### (2) Trilayer Structure of Rubber Layer-Fluororesin Layer (B)-Rubber Layer

Examples of this structure include a trilayer structure of rubber layer (A)-fluororesin layer (B)-rubber layer (A) and a trilayer structure of rubber layer (A)-fluororesin layer (B)-rubber layer (C1).

In the case in which the sealability is required, such as joint portions of fuel pipes, the rubber layer is preferably provided on each side of the rubber layer so as to secure the sealability. The inner and outer rubber layers may be the same as or different from each other.

In the case of a trilayer structure of rubber layer (A)-fluororesin layer (B)-rubber layer (C1), the rubber layer (C1) is preferably a layer formed from acrylonitrile butadiene rubber, hydrogenated acrylonitrile butadiene rubber, epichlorohydrin rubber, or a mixture of acrylonitrile butadiene rubber and acrylic rubber.

In order to improve the chemical resistance and the low fuel permeability, a fuel pipe may have a trilayer structure of rubber layer (A)-fluororesin layer (B)-rubber layer (C1) in which a fluoroelastomer layer is disposed as the rubber layer (C1) and the rubber layer (C1) is disposed as an inner layer of the pipe.

### (3) Trilayer Structure of Resin Layer-Rubber Layer (A)-Resin Layer

An example of this structure is a trilayer structure of fluororesin layer (B)-rubber layer (A)-fluororesin layer (B). The inner and outer resin layers may be the same as or different from each other.

### (4) Trilayer Structure of Fluororesin Layer (B)-Rubber Layer (A)-Rubber Layer (C1)

### (5) Structure Including Four or More Layers

In accordance with the purpose, any of the rubber layer (A), the rubber layer (C1), and the fluororesin layer (B) may be laminated on any of the trilayer structures (2) to (4). Another layer such as metal foil may be disposed, and an adhesive layer may be disposed between the layers excluding between the rubber layer (A) and the fluororesin layer (B).

Further, the polymer layer (C) may be laminated to provide a lined article.

The parameters such as thicknesses and shapes of the respective layers may be appropriately selected in accordance with the purpose and form of use, for example.

Further, for the purpose of improving the pressure resistance, a reinforcing layer such as a reinforcing thread may be appropriately provided.

The laminate of the present disclosure have excellently low fuel permeability, as well as excellent heat resistance, oil resistance, fuel oil resistance, LLC resistance, steam resistance, weather resistance, and ozone resistance, so that the laminate of the present disclosure is sufficiently tolerant of use under severe conditions, and thus can be used in a variety of applications.

For example, the laminate has properties suitable for seals such as gaskets, non-contact or contact packings (e.g., self-seal packings, piston rings, split ring packings, mechanical seals, and oil seals), bellows, diaphragms, hoses, tubes, and electric wires, which are required to have heat resistance, oil resistance, fuel oil resistance, antifreeze resistance, and steam resistance, of engine bodies, main drive systems, valve train systems, lubrication and cooling systems, fuel systems, and intake and exhaust systems of automobile engines, transmission systems of driveline systems, steering systems and braking systems of chassis, and basic electrical parts of electrical equipment, electrical parts of control systems, and electrical equipment accessories.

Specifically, the laminate can be used in the following applications:
gaskets such as cylinder head gaskets, cylinder head cover gaskets, sump packings, and general gaskets, seals such as O-rings, packings, and timing belt cover gaskets, and hoses such as control hoses, of engine bodies, anti-vibration rubber of engine mounts, and sealants for high-pressure valves in hydrogen storage systems;
shaft seals such as crankshaft seals and camshaft seals of main drive systems;
valve stem seals such as engine valves of valve train systems;
engine oil cooler hoses of engine oil coolers, oil return hoses, seal gaskets, water hoses used around radiators, and vacuum pump oil hoses of vacuum pumps, of lubrication and cooling systems;
oil seals, diaphragms, and valves of fuel pumps, fuel hoses such as filler (neck) hoses, fuel supply hoses, fuel return hoses, and vapor (evaporator) hoses, in-tank hoses, filler seals, tank packings, and in-tank fuel pump mounts of fuel tanks, tube bodies and connector O-rings of fuel pipe tubes, injector cushion rings, injector seal rings, injector O-rings, pressure regulator diaphragms, and check valves of fuel injection systems, needle valve petals, accelerator pump pistons, flange gaskets, and control hoses of carburetors, and valve seats and diaphragms of combined air controlling (CAC) systems in fuel systems; in particular, suitable for fuel hoses and in-tank hoses of fuel tanks;
intake manifold packings and exhaust manifold packings of manifolds, diaphragms, control hoses, and emission control hoses of exhaust gas recirculation (EGR) systems, diaphragms of BPT, after burn preventive valve seats of AB valves, throttle body packings of throttles, turbo oil hoses (supply), turbo oil hoses (return), turbo air hoses, intercooler hoses, and turbine shaft seals of turbochargers, of intake and exhaust systems;
transmission-related bearing seals, oil seals, O-rings, packings, and torque converter hoses, and mission oil hoses, ATF hoses, O-rings, and packings of ATs, of transmission systems;
power steering oil hoses of steering systems;
oil seals, O-rings, packings, brake oil hoses, air valves, vacuum valves, and diaphragms of master backs, piston cups (rubber cups) of master cylinders, caliper seals, and boots, of braking systems;
insulators and sheaths of electric wires (harnesses), and tubes of harness-holding parts of basic electrical parts;
cover materials for sensor lines of control system electrical parts; and
O-rings, packings, and air conditioner hoses of a car air conditioner of electrical equipment accessories, and wiper blades of exterior parts.

In addition to the field of automobiles, for example, the laminate of the present disclosure can be suitably used in the following applications: oil-resistant, chemical-resistant, heat-resistant, steam-resistant, or weather-resistant packings, O-rings, hoses, other sealants, diaphragms, and valves in a means of transportation, such as shipment and aircraft; similar packings, O-rings, sealants, diaphragms, valves, hoses, rolls, tubes, chemical-resistant coatings, and linings in chemical plants; fuel tubes and hoses used in small equipment such as lawnmowers; hoses and gaskets in the chemical treatment field; similar packings, O-rings, hoses, sealants, belts, diaphragms, valves, rolls, and tubes in food plant equipment and food-related devices (including household utensils); similar packings, O-rings, hoses, sealants, diaphragms, valves, and tubes in nuclear power plant equipment; similar packings, O-rings, hoses, sealants, diaphragms, valves, rolls, tubes, linings, mandrels, electric wires, flexible joints, belts, rubber plates, and weather strips in OA equipment and general industrial parts; and roll blades of plain paper copiers. For example, back-up rubber materials of PTFE diaphragms are poor in lubricity, and thus are worn down or broken during use. In contrast, the laminate of the present disclosure can solve such problems, and thus is suitably used.

In application to food-related rubber sealants, conventional rubber sealants cause problems such as scent absorption and contamination of foods by rubber chips. In contrast, the laminate of the present disclosure can solve such problems, and thus is suitably used. In the case of medical and chemical applications, rubber materials used as sealants for pipes using rubber sealant solvents disadvantageously swell by such solvents. In contrast, the laminate of the present disclosure can solve such problems because the rubber is covered with resin. In general industrial fields, the laminate can be suitably used for rubber rolls, O-rings, packings, and sealants in order to improve the strength, lubricity, chemical resistance, and permeability of rubber materials. In particular, the laminate can be suitably used for packing of lithium ion batteries because the laminate maintains the chemical resistance and the sealability simultaneously. Further, the laminate can be suitably used in applications requiring slidability with low friction.

In the case of the medical applications, the laminate of the present disclosure can be suitably used in the following applications: drug closures, bottle cap seals, can seals, medicinal tapes, medicinal pads, syringe packings, bases for percutaneous absorption drugs, teats of baby bottles, medical bags, catheters, infusion sets, coinjection tubes, cap liners, caps of vacuum blood collection tubes, syringe gaskets, infusion tubes, gaskets and caps of medical equipment, syringe tips, grommets, caps of blood collection tubes, cap seals, packings, O-rings, sheath introducers, dilator, guiding sheaths, blood circuits, cardiopulmonary bypass circuits, tubes for rotablators, catheter needles, infusion sets, infusion tubes, closed catheter access system s, infusion bags, blood bags, blood component separation bags, tubes for blood component separation bags, artificial blood vessels, arterial cannulae, stents, protective tubes for endoscope treatment devices, scope tubes for endoscopes, top overtubes for endoscopes, guiding tubes for pharyngeal transit, tubes for coronary artery bypass graft surgery, ileus tubes, tubes for percutaneous transhepatic biliary drainage, outer tubes for electrosurgical knives, outer tubes for ultrasonic scalpels, outer tubes for dissecting forceps, and bags for cell culture.

Examples of the formed articles for offshore uses to which the laminate of the present disclosure may be applied include tubes or hoses for offshore oil fields (including injection tubes and crude oil transport tubes).

The laminate of the present disclosure is particularly preferably used for tubes or hoses among these. In other words, the laminate is preferably a tube or a hose. The laminate can suitably be used as a fuel pipe tube or hose of automobiles among the tubes or hoses owing to its heat resistance and low fuel permeability.

The tube or hose of the present disclosure preferably includes the rubber layer (A) as the innermost layer. The rubber layer (A) has conductivity, so that by using the rubber layer (A) as the innermost layer, the flexibility of the laminate is improved, and even when static electricity is generated through flowing of a fluid in the tube or the hose, the tube or the hose is hardly charged, and furthermore, by including the fluororesin layer (B) adhered firmly to the rubber layer (A), the tube or the hose can be excellent in other properties such as low fuel permeability.

Although the embodiments have been described above, it will be understood that various changes in form and details are possible without departing from the gist and scope of the claims.
<1> According to a first aspect of the present disclosure,
   provided is a laminate comprising a rubber layer (A), and a fluororesin layer (B) laminated on the rubber layer (A), wherein
   the rubber layer (A) is a layer having conductivity and is formed from a rubber composition comprising a rubber and a carbon black, a content of the carbon black in the rubber composition is 1.0 to 100 parts by mass based on 100 parts by mass of the rubber, and a nitrogen adsorption specific surface area of the carbon black is 140 m²/g or less, and
   the fluororesin layer (B) is formed of a melt-fabricable fluororesin.
<2> According to a second aspect of the present disclosure,
   provided is the laminate according to the first aspect, wherein an average primary particle size of the carbon black is 28 nm or more.
<3> According to a third aspect of the present disclosure,
   provided is the laminate according to the first or second aspect, wherein the content of the carbon black is more than 8.0 parts by mass based on 100 parts by mass of the rubber.
<4> According to a fourth aspect of the present disclosure,
   provided is the laminate according to any one of the first to third aspects, wherein the rubber is a fluoroelastomer.
<5> According to a fifth aspect of the present disclosure,
   provided is the laminate according to any one of the first to fourth aspects, wherein a fuel permeability coefficient of the fluororesin is 2.0 g·mm/m²/day or less.
<6> According to a sixth aspect of the present disclosure,
   provided is the laminate according to any one of the first to fifth aspects, wherein the fluororesin is at least one selected from the group consisting of a chlorotrifluoroethylene-based copolymer and a tetrafluoroethylene/hexafluoropropylene/vinylidene fluoride copolymer.
<7> According to a seventh aspect of the present disclosure,
   provided is the laminate according to any one of the first to sixth aspects, wherein the rubber composition further comprises a basic polyfunctional compound, and a content of the polyfunctional compound in the rubber composition is 0.1 to 10 parts by mass based on 100 parts by mass of the rubber.
<8> According to an eighth aspect of the present disclosure,
   provided is the laminate according to any one of the first to seventh aspects, wherein the rubber composition further comprises a peroxide crosslinking agent.
<9> According to a ninth aspect of the present disclosure,
   provided is the laminate according to any one of the first to eighth aspects, wherein the rubber composition further comprises a polytetrafluoroethylene, a specific surface area of the polytetrafluoroethylene is less than 8 m²/g, an average particle size of the polytetrafluoroethylene is 0.01 to 1,000 μm, and a melt viscosity of the polytetrafluoroethylene at 380° C. is 1×10¹ to 7×10⁵ Pas.
<10> According to a tenth aspect of the present disclosure,
   provided is the laminate according to any one of the first to ninth aspects, wherein the rubber composition further comprises a silica, and an average value of products of “(particle size)×(roundness)” of the silica is 17.5 nm or more and 500 μm or less.
<11> According to an eleventh aspect of the present disclosure,
   provided is the laminate according to any one of the first to tenth aspects, wherein the rubber layer (A) and the fluororesin layer (B) are crosslinked and adhered to each other.
<12> According to a twelfth aspect of the present disclosure,
   provided is the laminate according to any one of the first to eleventh aspects, wherein an adhesive strength between the rubber layer (A) and the fluororesin layer (B) is 5 N/cm or more.
<13> According to a thirteenth aspect of the present disclosure,
   provided is the laminate according to any one of the first to twelfth aspects, wherein the laminate is a tube or a hose.

### EXAMPLES

Next, the embodiments of the present disclosure are described with reference to Examples, but the present disclosure is not intended to be limited by these Examples.

The parameters in the Examples were determined by the following methods.

### <Composition of CTFE/TFE/PPVE Copolymer>

The measurement was performed by ¹⁹F-NMR analysis.

### <Melt Flow Rate (MFR) of CTFE/TFE/PPVE Copolymer>

The MFR of the CTFE/TFE/PPVE copolymer was determined by measuring the weight (g) of the polymer flowed out of a nozzle (diameter: 2 mm, length: 8 mm) per unit time (10 minutes) at 297° C. under a load of 5 kg using a melt indexer (for example, manufactured by Toyo Seiki Seisaku-sho, Ltd.).

### <Fuel Permeability Coefficient>

Pellets of the CTFE/TFE/PPVE copolymer were put into a mold having a diameter of 120 mm and mounted on a press heated up to 300° C. and the pellets were melt-pressed at a pressure of about 2.9 MPa, whereby a sheet having a thickness of 0.12 mm was obtained. This sheet was then processed to have a diameter of 45 mm and a thickness of 120 μm. This sheet was put into a SUS316 permeability coefficient measurement cup having an inner diameter of 40 mmϕ and a height of 20 mm. Here, the cup contained 18 mL of CE10 (fuel prepared by mixing a mixture of isooctane and toluene at a ratio by volume of 50:50 and 10 vol % of ethanol). The mass change at 60° C. was determined for 1000 hours. The fuel permeability coefficient (g·mm/m²/day) was calculated from the mass change per hour (the period during which the mass change is constant at the initial stage of the measurement), and the surface area and thickness of the sheet at the liquid-contact portion.

### <Average Particle Size of PTFE>

Using a laser diffraction type particle size distribution measurement apparatus (manufactured by Japan Laser Corporation), the particle size distribution was determined at a pressure of 0.1 MPa and a measurement time of three seconds without cascade, and the value of 50% of the cumulative volume of particle size distribution was taken as the average particle size.

### <Specific Surface Area of PTFE>

The surface roughness was measured by the BET method using a surface analyzer (trade name: BELSORP-mini II, manufactured by MicrotracBEL Corp.). A mixed gas of 30% nitrogen and 70% helium was used as a carrier gas, and liquid nitrogen was used for cooling.

### <Melting Point of PTFE>

The melting point of PTFE was determined by temperature calibration using a differential scanning calorimeter RDC220 (DSC) manufactured by SII NanoTechnology Inc, using indium and lead as standard samples in advance, placing about 3 mg of PTFE powder in an aluminum pan (crimp container), heating the temperature range of 250 to 380° C. at 10° C./min under an air flow of 200 ml/min, performing differential scanning calorimetry, and using the minimum point of the heat of melting in the above range as the melting point.

### <Melt Viscosity of PTFE>

The measurement was performed by pre-heating a 2-g sample at 380° C. for 5 minutes and keeping it at the above temperature under a load of 0.7 MPa using a flow tester (manufactured by Shimadzu Corporation) and a 2ϕ-8L die in accordance with ASTM D 1238.

### <Particle Size of Silica, Roundness, and Average Value of Products of “(Particle Size)×(Roundness)”>

An SEM image of silica was taken using a scanning electron microscope SU8020 (manufactured by Hitachi High-Tech Corporation). The processing and analysis of the image were performed using general image analysis software WinROOF (manufactured by MITANI CORPORATION).

### <Average Primary Particle Size of Carbon Black>

The average primary particle size of carbon black is an arithmetic average particle size, and was determined by observing carbon black with an electron microscope.

### <Nitrogen Adsorption Specific Surface Area of Carbon Black>

It was determined by the BET equation using the nitrogen adsorption method in conformity with JIS K 6217-2.

### <Adhesive Strength of Laminate>

The laminate obtained was cut into three strips having a width of 10 mm and a length of 40 mm, and the fluororesin sheet was peeled off to provide a margin for holding, whereby the test pieces were prepared. For each of these test pieces, in order to determine the bond strength of the bonded surface alone without the adhesive strength of the interface between the rubber layer and the fluororesin layer, the interface between the rubber layer and the fluororesin layer was slowly stretched by hand once to increase the grip section by 2 to 3 mm. Then, the test piece was subjected to a peeling test at 25° C. and a tensile rate of 50 mm/min using an autograph (AGS-J 5 kN, manufactured by Shimadzu Corporation) in conformity with JIS K 6256 (Determination of adhesion strength for vulcanized rubber), whereby the adhesive strength was determined and the average value of data (N=3) was calculated.

### <Resistance Value of Rubber Layer>

The rubber sheet (before crosslinking) having a thickness of about 2 mm was cut and pressed at 170° C. for 30 minutes to produce a sample sheet of 4 cm×7 cm. Using an analog insulation resistance tester 24060 (manufactured by Yokogawa Test & Measurement Corporation), the probe terminal was brought into contact with both ends of the sample sheet, and the surface resistance value of the sample sheet when a voltage of 500 V was applied was measured.

### Examples 1 to 12 and Comparative Examples 1 to 6

### (Production of Fluororesin Sheet)

A CTFE/TFE/PPVE copolymer having the following physical properties was pressed at 280° C. for 10 minutes to produce a fluororesin sheet (thickness: 0.12 mm).
CTFE/TFE/PPVE=21.3/76.3/2.4 (mol %)
MFR=29.2 g/10 minutes
Fuel permeability coefficient=0.4 g·mm/m²/day

### (Production of Rubber Composition (Rubber Sheet))

Details of the materials used to produce the rubber composition are shown below.
Fluoroelastomer: Dai-El G902, manufactured by Daikin Industries, Ltd.
PTFE powder: TF9205, manufactured by 3M Japan Limited (PTFE micropowder, average particle size: 7.7 μm, specific surface area: 1.6 m²/g, melting point: 327° C., melt viscosity: 139 Pa·s)
Silica: Sidistar (R) R300, manufactured by Elkem Corporation (average particle size: 83.4 nm, average roundness: 0.88, average value of products of” (particle size)×(roundness) “: 74.4 nm)
Crosslinking aid: triallyl isocyanurate (TAIC), manufactured by Nihon Kasei Co., Ltd.
Crosslinking agent: peroxide-crosslinking agent, Perhexa 25B, manufactured by NOF Corp.
Basic polyfunctional compound: N,N′-dicinnamylidene-1,6-hexamethylenediamine (V-3, manufactured by Daikin Industries, Ltd.)
Carbon black: Details are shown in Table 1.

TABLE 1

| | | | Average | Nitrogen |
|---|---|---|---|---|
| | | | primary | adsorption |
| | | | particle | specific |
| | Product | Manufacturer | size | surface area |
| Number | name | name | (nm) | (m²/g) |
| A | #3400B | manufactured by | 21 | 165 |
| | | Mitsubishi Chemical | | |
| | | Corporation | | |
| B | #3230B | manufactured by | 23 | 220 |
| | | Mitsubishi Chemical | | |
| | | Corporation | | |
| C | #3050B | manufactured by | 50 | 50 |
| | | Mitsubishi Chemical | | |
| | | Corporation | | |
| D | #3030B | manufactured by | 55 | 32 |
| | | Mitsubishi Chemical | | |
| | | Corporation | | |
| E | #4400 | manufactured by | 38 | 50 |
| | | Tokai Carbon Co., | | |
| | | Ltd. | | |
| F | #5500 | manufactured by | 25 | 225 |
| | | Tokai Carbon Co., | | |
| | | Ltd. | | |
| G | ENSACO 250G | manufactured by | 45 | 65 |
| | | TIMCAL Ltd | | |
| H | ENSACO 260G | manufactured by | 43 | 70 |
| | | TIMCAL Ltd | | |
| I | ENSACO 350G | manufactured by | 12 | 770 |
| | | TIMCAL Ltd | | |
| J | Asahi F-200Gs | manufactured by | 38 | 55 |
| | | Asahi Carbon Co., | | |
| | | Ltd. | | |
| K | Asahi AX-015 | manufactured by | 19 | 145 |
| | | Asahi Carbon Co., | | |
| | | Ltd. | | |
| L | MT carbon | manufactured by | 300 | 10 |
| | | Degussa-Huels AG | | |

The materials shown in Table 2 were kneaded using an 8-inch open roll. Thereby, a sheet-shaped rubber composition (rubber sheet) having a thickness of about 2 mm was obtained.

For the rubber composition, the maximum torque value (MH) and the minimum torque value (ML) at 170° C. were determined using MDR (Model: MDR2000 manufactured by Alpha Technologies), and then the induction time (T10) and the optimum vulcanizing time (T90) were determined. The measurement results are shown in Table 2. T10 means the time at which {(MH)−(ML)}×0.1+ML equals to the value in the table; T90 means the time at which {(MH)−(ML)}×0.9+ML equals to the value in the table; and MH and ML are values determined in conformity with JIS K 6300-2.

### (Production of Laminate)

The rubber sheet having a thickness of about 2 mm and the fluororesin sheet having a thickness of about 0.12 mm were laminated, and a fluororesin film (thickness: 10 μm) having a width of about 50 mm was inserted between the sheets at an end of the laminate. The resulting laminate was pressed at 170° C. for 30 minutes, whereby a sheet-shaped laminate was obtained. The results are shown in Table 2.

TABLE 2

| Example | Example | Example | Example | Example | Example | Example | Example | Example | Example |
|---|---|---|---|---|---|---|---|---|---|
| 1 | 2 | 3 | 4 | 5 | 6 | 7 | 8 | 9 | 10 |

Formulation of rubber composition (parts by mass)

| | | | | | | | | | | |
|---|---|---|---|---|---|---|---|---|---|---|
| Fluoroelastomer | 100 | 100 | 100 | 100 | 100 | 100 | 100 | 100 | 100 | 100 |
| Carbon black A | | | | | | | | | | |
| Carbon black B | | | | | | | | | | |
| Carbon black C | 15.0 | | | | | | | | | |
| Carbon black D | | 15.0 | | | | | | | | |
| Carbon black E | | | 15.0 | | | | | | | |
| Carbon black F | | | | | | | | | | |
| Carbon black G | | | | 15.0 | | | | | | |
| Carbon black H | | | | | 15.0 | | 7.0 | 9.0 | 10.0 | 10.0 |
| Carbon black I | | | | | | | | | | |
| Carbon black J | | | | | | 15.0 | | | | |
| Carbon black K | | | | | | | | | | |
| Carbon black L | | | | | | | | | | |
| PTFE powder | | | | | | | | | | 30.0 |
| Silica | | | | | | | | | | |
| Cross-linking aid | 3.0 | 3.0 | 3.0 | 3.0 | 3.0 | 3.0 | 3.0 | 3.0 | 3.0 | 3.0 |
| Cross-linking agent | 2.0 | 2.0 | 2.0 | 2.0 | 2.0 | 2.0 | 2.0 | 2.0 | 2.0 | 2.0 |
| Basic | 3.0 | 3.0 | 3.0 | 3.0 | 3.0 | 3.0 | 3.0 | 3.0 | 3.0 | 3.0 |
| polyfunctional | | | | | | | | | | |
| compound | | | | | | | | | | |
| Total | 123.0 | 123.0 | 123.0 | 123.0 | 123.0 | 123.0 | 115.0 | 117.0 | 118.0 | 148.0 |

Crosslinking properties of rubber composition (170° C.)

| | | | | | | | | | | |
|---|---|---|---|---|---|---|---|---|---|---|
| ML (dNm) | 1 | 1 | 1 | 1 | 1 | 1 | 1 | 1 | 1 | 1 |
| MH (dNm) | 25 | 23 | 24 | 27 | 28 | 26 | 17 | 19 | 21 | 26 |
| T10 (min) | 1 | 1 | 1 | 1 | 1 | 1 | 1 | 1 | 1 | 1 |
| T90 (min) | 3 | 4 | 4 | 3 | 3 | 4 | 3 | 3 | 3 | 3 |

Property of laminate

| | | | | | | | | | | |
|---|---|---|---|---|---|---|---|---|---|---|
| Adhesive | 7.2 | 12.7 | 6.7 | 6.1 | 8.2 | 6.0 | 8.0 | 9.3 | 8.4 | 9.6 |
| strength (N/cm) | | | | | | | | | | |

Property of rubber layer

| | | | | | | | | | | |
|---|---|---|---|---|---|---|---|---|---|---|
| Resistance | 0.015 | 2 | 0.006 | 0 | 0.003 | 0.03 | 0.5 | 0.02 | 0.01 | 0.02 |
| value (MΩ) | | | | | | | | | | |

| | Example | Example | Comparative | Comparative | Comparative | Comparative | Comparative | Comparative |
|---|---|---|---|---|---|---|---|---|
| | 11 | 12 | Example 1 | Example 2 | Example 3 | Example 4 | Example 5 | Example 6 |
| Formulation of rubber composition (parts by mass) | | | | | | | | |
| Fluoroelastomer | 100 | 100 | 100 | 100 | 100 | 100 | 100 | 100 |
| Carbon black A | | | 15.0 | | | | | |
| Carbon black B | | | | 15.0 | | | | |
| Carbon black C | | | | | | | | |
| Carbon black D | | | | | | | | |
| Carbon black E | | | | | | | | |
| Carbon black F | | | | | 15.0 | | | |
| Carbon black G | | | | | | | | |
| Carbon black H | 10.0 | 10.0 | | | | | | |
| Carbon black I | | | | | | 15.0 | | |
| Carbon black J | | | | | | | | |
| Carbon black K | | | | | | | 15.0 | |
| Carbon black L | | | | | | | | 15.0 |
| PTFE powder | | 30.0 | | | | | | |
| Silica | 20.0 | 20.0 | | | | | | |
| Cross-linking aid | 3.0 | 3.0 | 3.0 | 3.0 | 3.0 | 3.0 | 3.0 | 3.0 |
| Cross-linking agent | 2.0 | 2.0 | 2.0 | 2.0 | 2.0 | 2.0 | 2.0 | 2.0 |
| Basic | 3.0 | 3.0 | 3.0 | 3.0 | 3.0 | 3.0 | 3.0 | 3.0 |
| polyfunctional | | | | | | | | |
| compound | | | | | | | | |
| Total | 138.0 | 168.0 | 123.0 | 123.0 | 123.0 | 123.0 | 123.0 | 123.0 |
| Crosslinking properties of rubber composition (170° C.) | | | | | | | | |
| ML (dNm) | 1 | 1 | 1 | 1 | 1 | 2 | 1 | 1 |
| MH (dNm) | 36 | 39 | 35 | 30 | 29 | 41 | 29 | 19 |
| T10 (min) | 1 | 1 | 1 | 1 | 1 | 1 | 1 | 1 |
| T90 (min) | 5 | 5 | 3 | 3 | 3 | 3 | 4 | 4 |
| Property of laminate | | | | | | | | |
| Adhesive | 8.9 | 15.7 | 1.9 | <1 | 1.9 | <1 | 3.5 | 14.0 |
| strength (N/cm) | | | | | | | | |
| Property of rubber layer | | | | | | | | |
| Resistance | 0.3 | 5 | 0.0015 | 2 | 0.1 | 0.001 | 0.03 | ∞ |
| value (MΩ) | | | | | | | | |

1. A laminate comprising a rubber layer (A), and a fluororesin layer (B) laminated on the rubber layer (A), wherein
the rubber layer (A) is a layer having conductivity and is formed from a rubber composition comprising a rubber and a carbon black, a content of the carbon black in the rubber composition is 1.0 to 100 parts by mass based on 100 parts by mass of the rubber, and a nitrogen adsorption specific surface area of the carbon black is 140 m²/g or less, and
the fluororesin layer (B) is formed of a melt-fabricable fluororesin.
